(19) United States
(12) Patent Application Publication
(10) Pub. No.: US 2007/0005958 A1
(43) Pub. Date: Jan. 4, 2007

(54) Cipher method and system for multicast service

(75) Inventors: Yu-Ching Hsu, Shueilin Township (TW); Chia-Chin Lin, Chaojhou Township (TW); Shiao-Li Tsao, Taipei City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/220,587

(22) Filed: Sep. 8, 2005

(30) Foreign Application Priority Data
Jul. 1, 2005 (TW) 094122281

(51) Int. Cl. H04L 9/00

(52) U.S. Cl. 713/163

(57) ABSTRACT

A cipher method and system for multicast service. A group includes multiple user equipment, each having a respective key. The keys are orthogonal to one another. A content provider provides a raw message to the user equipment of the group. A BM-SC server has a key set composed of the respective keys of all user equipment of the group to encipher the raw message to thus obtain an enciphered message for broadcast. All user equipment of the group receives and deciphers the enciphered message with the respective keys. When a user equipment leaves the group, the key set held by BM-SC is updated by removing the key of the leaving user equipment.

### BACKGROUND OF THE INVENTION

1. Field of the Invention

The invention relates to a technical field of multicast service and, more particularly, to a cipher method and system for multicast service.

2. Description of Related Art

The 3rd Generation Partnership Project (3GPP) has recommended the Multimedia Broadcast Multicast Service (MBMS), as shown in the configuration of a typical MBMS (multicast service) system of FIG. 1. In order to send a message to N user equipments UE₁-UEₙ of a special group 12, the message provided by the content provider 11 is enciphered and broadcasted by a broadcast multi-service center (BM-SC) server 14. All user equipments in the system can receive the enciphered message but only the N user equipments UE₁-UEₙ of the special group 12 can have a key k_{A} to decipher the enciphered message and accordingly receive the message. Thus, the content provider 11 can send the message to the N user equipments UE₁-UEₙ of the special group 12, and the MBMS is achieved.

In the cited MBMS, each user equipment UE₁˜UEₙ of the group 12 has the same key k_{A} to decipher the enciphered message. However, when a user equipment UE₁ leaves the group 12, the member of the group 12 is changed. In this case, the key k_{A} has to be changed to make sure that only the user equipments UE₂˜UEₙ included in the updated group 12 can have a new key k_{B}. However, such an updated procedure needs to use the BM-SC server 14 to update the key in a unicast manner for each user equipment UE₂˜UEₙ, which results in a lot of signaling overhead and time delay. Especially, when the users of the group increase, the probability of member change in the group is relatively increased, which further causes the system to change the key frequently.

Therefore, it is desirable to provide an improved cipher method and system for multicast service to mitigate and/or obviate the aforementioned problems.

### SUMMARY OF THE INVENTION

The object of the invention is to provide a cipher method and system for multicast service, which can make it as an independent event when a user of a group leaves the group and thus does not cause the problem of changing a new key for each remaining user of the group.

In accordance with one aspect of the invention, a cipher system for multicast service is provided. The system includes a group, which has multiple user equipments with respective keys orthogonal to one another; a content provider, which provides a message to the user equipments of the group; and a broadcast multi-service center (BM-SC) server, which has a key set composed of the keys of all user equipments of the group to accordingly encipher the message provided by the content provider so as to obtain an enciphered message for broadcast, such that all user equipments of the group receive and decipher the enciphered message with the respective keys, thereby correctly receiving the message.

In accordance with another aspect of the invention, a cipher method for multicast service is provided. The multicast service uses a content provider to provide a message to multiple user equipments of a group, a broadcast multi-service center (BM-SC) server to encipher the message provided by the content provider to thus obtain an enciphered message for broadcast, and the user equipments of the group to receive and decipher the enciphered message. The method includes the steps of (A) assigning a respective key to each user equipment of the group, wherein the respective keys are orthogonal to one another; (B) providing a message by the content provider; (C) using the broadcast multi-service center (BM-SC) server to encipher the message with a key set composed of the respective keys of all user equipments of the group, thereby obtaining an enciphered message for broadcast; and (D) receiving and deciphering the enciphered message with the respective keys of the user equipments of the group, thereby correctly receiving the message.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a configuration of a typical multicast service system; and

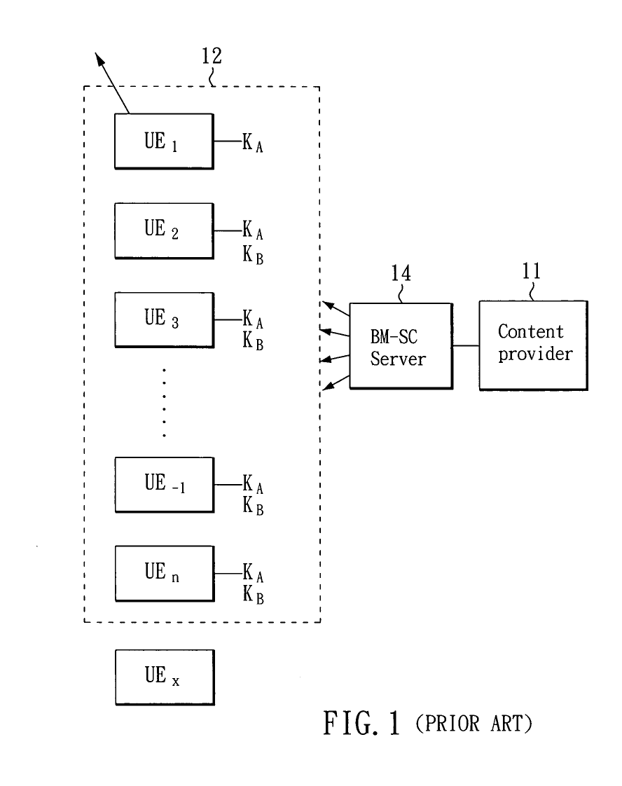

FIG. 2 is a block diagram of a configuration of a multicast service system in accordance with the invention.

### DETAILED DESCRIPTION OF THE PREFERRED EMBODIMENT

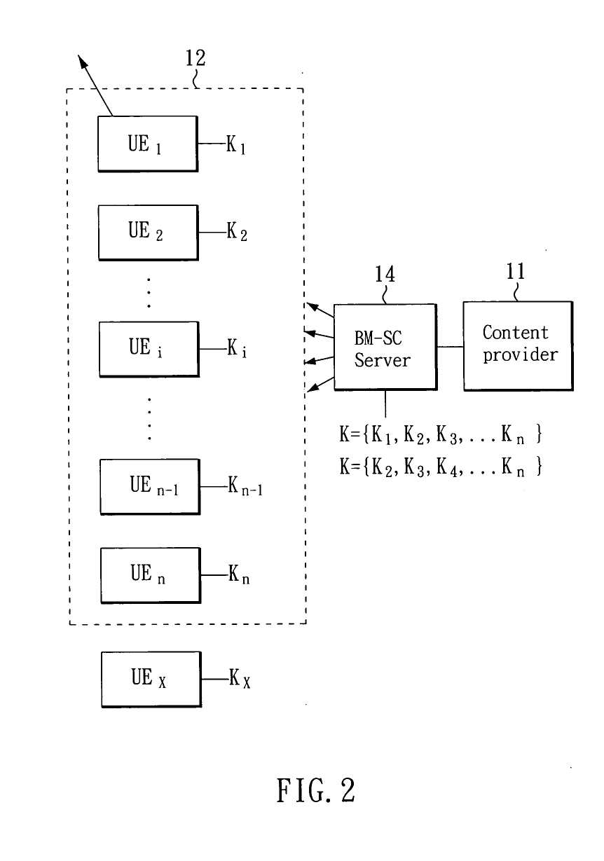

With reference to FIG. 2, there is shown a block diagram of a configuration of a multicast service system according to the invention. As shown in FIG. 2, a content provider 11 provides a message to user equipments UEᵢ (i=1˜n) of a special group 12, wherein each user equipment UEᵢ possesses a respective key kᵢ (i=1˜n), and the keys are orthogonal to one another. The message provided by the content provider 11 is enciphered by a broadcast multi-service center (BM-SC) server 14 for broadcast, and received by the user equipments UEᵢ of a specific group 12 for deciphering with the respective key kᵢ. Thus, the message sent by the content provider 11 is correctly received by the user equipments UEᵢ of the specific group 12, and so as to achieve the multicast service in which messages from the content provider 11 can be sent to the user equipments UEᵢ of the specific group 12.

In the system, each user equipment UEᵢ of the specific group 12 is assigned with a different key kᵢ, and the keys are orthogonal to one another (having orthogonal feature, i.e., a product of two keys is zero). The BM-SC server 14 has a key set K={k₁, k₂, k₃, . . . kₙ} composed of the keys of all user equipments UEᵢ of the group 12. The message provided by the content provider 11 is enciphered by the BM-SC server 14 with an enciphering function f(d, K)=d*(SUM(K)) for broadcast, where d represents original data of the message, SUM is an addition function, and * indicates a multiplication.

When an enciphered message is received by each user equipment UEᵢ of the group 12, a deciphering function g(c, ki)=c*kᵢ/||kᵢ|| is applied for deciphering the enciphered message, where c is the enciphered data obtained from enciphering the message, and ||kᵢ|| indicates a length of key kᵢ.

The enciphering function f(d, K)=d*(SUM(K)) performs an enciphering by summing all keys kᵢ of the user equipments UEᵢ of the group 12 and then multiplying the summation with d. Conversely, on deciphering, since the keys kᵢ assigned to the user equipments UEᵢ are orthogonal to one another, a product of the keys is obtained as kᵢ*kⱼ=0 for either two of the user equipments UEᵢ and UEⱼ of the group 12, where kᵢ, kⱼ belong to K, and kᵢ*kᵢ=||kᵢ||. Thus, the deciphering function g(c, kᵢ)=c*kᵢ/||kᵢ|| can accurately restore the original data of the message. Further, when a user equipment UEₓ that does not belong to the group 12 tries to decipher the enciphered message with a key kₓ, it cannot work because the key kₓ does not belong to the key set K.

With the aforementioned encipher method, when a user equipment UE₁ leaves the group 12, only the key k₁ of the user equipment UE₁ is removed from the key set K included in the BM-SC server 14 (K={k₂, k₃, k₄, . . . kₙ}), without changing a new key for each existing user. In this case, even the user equipment UE₁ uses the key k₁ to decipher, it cannot work because the key k₁ does not belong to the key set K any more.

An example is given for further description of the invention, wherein a group 12 includes user equipments UE₁, UE₂ and UE₃ with the respective keys k₁=(3,0,0), k₂=(0,2,0) and k₃=(0,0,5), and thus the key set K={k₁, k₂, k₃} is obtained, where the key kI has a length of nine, the key k2 has a length of four, and the key k3 has a length of 25. The content provider 11 provides a message with original data d=8, which is enciphered by the BM-SC server 14 with the enciphering function as follows.

$$\begin{matrix}f ( d , K ) = d * ( SUM ( K ) ) \\ = 8 * ( SUM ( {k}_{1} , {k}_{2} , {k}_{3} ) ) \\ = 8 * ( ( 3 , 0 , 0 ) + ( 0 , 2 , 0 ) + ( 0 , 0 , 5 ) ) \\ = 8 * ( 3 , 2 , 5 ) \\ = ( 24 , 16 , 40 ) \\ = c .\end{matrix}$$

The enciphered data c is broadcasted by the BM-SC server 14. The user equipments UE₁, UE₂ and UE₃ can decipher c with the respective keys k₁=(3,0,0), k₂=(0,2,0) and k₃=(0,0,5), thereby obtaining the original data d as follows:
UE₁: (24,16,40)*(3,0,0)/9=72/9=8
UE₂: (24,16,40)*(0,2,0)/4=32/4=8
UE₃: (24,16,40)*(0,0,5)/25=200/25=8.

In this case, when a user equipment UE₄ tries to decipher c with a key k₄=(2,0,0) that does not belong to the key set K={k₁, k₂, k₃}, it results in (24,16,40)*(2,0,0)/4=48/4=12≠8.

In addition, when the user equipment UE₁ leaves the group 12, the BM-SC server 14 removes the key k₁ of the user equipment UE₁ from the key set K, and thus a new key set K={k₂, k₃} is obtained. At this point, the content provider 11 provides another message with original data d=7, which is further enciphered by the BM-SC server 14 with the enciphering function as follows:

$$\begin{matrix}f ( d , K ) = d * ( SUM ( K ) ) \\ = 7 * ( SUM ( {k}_{2} , {k}_{3} ) ) \\ = 7 * ( ( 0 , 2 , 0 ) + ( 0 , 0 , 5 ) ) \\ = 7 * ( 0 , 2 , 5 ) \\ = ( 0 , 14 , 35 ) \\ = c .\end{matrix}$$

The enciphered message c is broadcasted by the BM-SC server 14. The user equipments UE₂ and UE₃ can decipher c with the respective keys k₂=(0,2,0) and k₃=(0,0,5), thereby obtaining the original data d as follows:
UE₂: (0,14,35)*(0,2,0)/4=28/4=7
UE₃: (0,14,35)*(0,0,5)/25=175/25=7.

However, the user equipment UE₁ left deciphers c with the key k₁=(3,0,0) not belong to the new key set K to thus obtain d=(0,14,35)*(3,0,0)/9=0/9=0≠7.

From the above description, it is known that the invention assigns the keys orthogonal to one another to each user of a specific group, enciphers original data with an enciphering function f(d, K)=d*(SUM(K)), and deciphers the original data with an deciphering function g(c, ki)=c*kᵢ/||kᵢ||. Accordingly, it is regarded as an independent event when a user leaves the group, which does not cause the problem of changing a new key for each remaining user of the group.

Although the present invention has been explained in relation to its preferred embodiment, it is to be understood that many other possible modifications and variations can be made without departing from the spirit and scope of the invention as hereinafter claimed.

What is claimed is:

1. A cipher system for multicast service, comprising:
a group, which has multiple user equipments with respective keys orthogonal to one another;
a content provider, which provides a message to the user equipments of the group; and
a broadcast multi-service center (BM-SC) server, which has a key set composed of the keys of all user equipments of the group to accordingly encipher the message provided by the content provider so as to obtain an enciphered message for broadcast, such that all user equipments of the group receive and decipher the enciphered message with the respective keys, thereby correctly receiving the message.

2. The system as claimed in claim 1, wherein the BM-SC server enciphers the message provided by the content provider with an enciphering function f(d, K)=d*(SUM(K)), where d represents original data of the message, SUM is an addition function, and * indicates a multiplication.

3. The system as claimed in claim 2, wherein all user equipments of the group deciphers the enciphered message with a deciphering function g(c, kᵢ)=c*kᵢ/||kᵢ||, where kᵢ indicates the respective key of a user equipment, c represents enciphered data of the message, and ||kᵢ|| indicates a length of the key kᵢ.

4. The system as claimed in claim 1, wherein the BM-SC server removes the respective key of a user equipment from the key set when the user equipment leaves the group.

5. A cipher method for multicast service, the multicast service using a content provider to provide a message to multiple user equipments of a group, a broadcast multi-service center (BM-SC) server to encipher the message provided by the content provider to thus obtain an enciphered message for broadcast, and the user equipments of the group to receive and decipher the enciphered message, the method comprising the steps of:
(A) assigning a respective key to each user equipment of the group, wherein the respective keys are orthogonal to one another;
(B) providing a message by the content provider;
(C) using the broadcast multi-service center (BM-SC) server to encipher the message with a key set composed of the respective keys of all user equipments of the group, thereby obtaining an enciphered message for broadcast; and
(D) receiving and deciphering the enciphered message with the respective keys of the user equipments of the group, thereby correctly receiving the message.

6. The method as claimed in claim 5, wherein the BM-SC server in step (C) enciphers the message provided by the content provider with an enciphering function f(d, K)=d*(SUM(K)), where d represents original data of the message, SUM is an addition function, and * indicates a multiplication.

7. The method as claimed in claim 6, wherein all user equipments of the group in step (D) deciphers the enciphered message with a deciphering function g (c, kᵢ)=c*kᵢ/||kᵢ||, where kᵢ indicates the respective key of a user equipment, c represents enciphered data of the message, and ||kᵢ|| indicates a length of the key kᵢ.

8. The method as claimed in claim 5, further comprising:
(E) using the BM-SC server to remove the respective key of a user equipment from the key set when the user equipment leaves the group.
